(19) United States
(12) Patent Application Publication
(10) Pub. No.: US 2010/0073411 A1
(43) Pub. Date: Mar. 25, 2010

(54) Ink Jet Recording Device

(75) Inventors: Takuya Moriai, Hitachi (JP); Nobuhiro Harada, Hitachi (JP); Koji Horikawa, Hitachi (JP); Shinichi Kobayashi, Mito (JP); Masahiko Sakurada, Hitachi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Industrial Equipment Systems Co., Ltd., Tokyo (JP)

(21) Appl. No.: 12/524,925

(22) PCT Filed: Feb. 23, 2007
(86) PCT No.: PCT/JP2007/053982

§ 371 Date: Sep. 18, 2009

(51) Int. Cl. B41J 29/38

(52) U.S. Cl. 347/9; 347/55

(57) ABSTRACT

A conventional ink jet recording device has a phenomenon of such that a transverse pitch between longitudinal dot column of a first line and that of a second line of character lines to be printed becomes narrower than that between other longitudinal dot columns when printing out on a printing object traveling in high speed.

Consequently, an ink jet recording device of the invention makes an interval between ink droplets on the longitudinal dot column of the first line and those on the longitudinal dot column of the second line longer than an interval between the ink droplets on the longitudinal dot column of a subsequent line following the second line.

### TECHNICAL FIELD

The present invention relates to an ink jet recording device to be used for marking on products.

### BACKGROUND ART

As ink jet recording devices in the past, there has been an apparatus disclosed in JP-A-9-136420 such that it controls an electrification amount to be applied to ink droplets complied with a speed of an object, which is to be printed, being traveled by feed means such as a conveyor.

In this related art, an encoder provided in the feed means detects a traveling speed (feeding speed of the feed means) of the printing object whether that speed is varied. The electrification amount to be applied to the ink droplets is then corrected, and a printing for one line starts in accordance with that output pulses, in response to an interval of the output pulses detected by the encoder.

In this related art, when the traveling speed of the printing object became slow, an electrostatic repulsion and an air resistance variation, which are given to the ink droplets spouted from a nozzle, can be reduced for a printing of a succeeding line, in relation to the ink droplets spouted from the nozzle for the printing of a preceding line.

On the other hand, when a relative speed between the nozzle and the printing object is constant, a time interval between the respective lines becomes also constant. However, it has become clear that an influence on the air resistance, which is given to the ink droplets spouted from the nozzle, is significant for the printing of the preceding line, when the traveling speed of the printing object is higher against an assumed speed in the related art, for example, the printing object travels at the relative speed equal to or higher than 100 m/min.

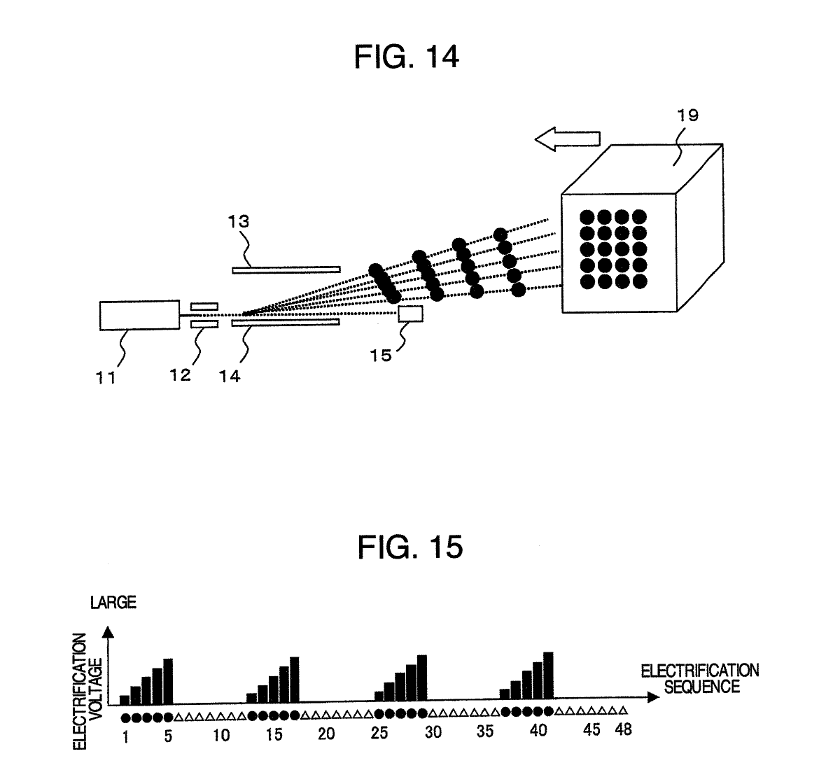

First, a description will be concerned with a case of a conventional low speed printing with reference to FIG. 14, that is, the printing is performed by an ink jet recording device in a condition where the relative speed between the nozzle and the printing object is slow. In addition, dots arranged on one line, in which the ink droplets spouted from the nozzle is printed by changing a flight trajectory, are referred to as a longitudinal dot column. A character and a symbol, in which the longitudinal dot column is arrayed in plural number as arrayed dots, are referred to as a matrix (dot matrix) character. Hereinafter, the description will be as follows.

FIG. 14 is a conceptual diagram of an ink jet recording device for performing the low speed printing, and shows a relation between a constitution in which the ink droplets are formed and the matrix character is printed on the printing object, and an electrification waveform which controls electric charges to be given to the ink droplets composing the matrix character to be printed.

In FIG. 14, a constitution, which shows the printing on a printing object 19 to be traveled in an arrow direction, includes a nozzle 11 that vibrates a pressurized ink and spouts it from that, electrification electrodes 12 that are provided on a position which is separated from the ink (referred to as an ink column from its configuration) extended from the nozzle 11 and take an electric charge to the ink droplets, a deflection electrode 13 that generates an electric field for varying the flight trajectory of electrified ink droplets, and a gutter 15 that catches up and collects non-electrified ink droplets. In the case of the ink jet recording device, the above-mentioned constitution is provided on a non-illustrated head unit (hereinafter, referring to as a head).

In FIG. 14, the drawing represents two ink droplet groups: one ink droplet group containing a first line to a fourth line which are flied on the flight trajectory; and another ink droplet group made into a matrix character formed by adhering their ink droplets to the printing object 19 to be printed it thereon.

An electrification signal sent from a control unit in the ink jet recording device is sent to the electrification electrodes 12 in synchronism with a condition where the ink is made into the ink droplets. A drawing to be explained the electrification signal in FIG. 15 shows that a horizontal axis represents an order of electrifying the ink droplets and a vertical axis represents a magnitude of an electrification voltage. As shown in the drawing, the electrification signal is used for such that the electrification voltage varied for each of the ink droplets is generated between the electrification electrodes 12 and the nozzle 11 to apply the electric charge to the ink droplets in response to a deflection amount of the ink droplet in relation to the ink droplets to be used for the printing. The electrification signal is also used for making the ink into the ink droplets in a condition where the electrification voltage remains “0” so that the ink droplets are collected at the gutter 15 without jumping out them from the head.

In FIG. 15, a condition of the ink droplets is represented by a black filled circle () and a triangle (Δ) in relation to the electrification waveform, in which the black filled circle represents charged ink droplets to be used for the printing and the triangle represents the non-charged ink droplets which are not used for the printing. The non-charged ink droplets have a role containing that it becomes a blank domain of the matrix character to be printed and it adjusts a time period between the longitudinal dot columns. In either case, the electric charge is not applied to the ink droplets such that the formed ink droplets are collected at the gutter 15 without jumping out them from the head.

A slow speed printing condition shown in FIG. 14 and FIG. 15 indicates that the speed of traveling the printing object is relatively slow in comparison with a time when the ink droplets spouted from the nozzle 11 are arranged on the printing object 19 in a predetermined number of pieces. For this reason, it is necessary to adjust the time from a printing termination of the preceding longitudinal dot column to a printing start of the succeeding longitudinal dot column.

The non-charged ink droplets of a pieces which are not printed are added, as used amount, to the respective longitudinal dot columns of the matrix character containing four lines, each of which is made up of longitudinal Y dots which is a column of printed dots made up of the ink droplets of Y pieces. In the case of FIG. 15, the seven pieces of non-charged ink droplets, which are not printed out, are added to five pieces of the ink droplets to be used actually for the printing, which is handled as longitudinal dot columns, in relation to the matrix character made up of longitudinal five dots and transverse four lines.

In this way, the non-charged ink droplets are added to between the ink droplets to which the electric charge is applied and the deflection is applied, and the ink droplets are printed, so that the time interval between the respective longitudinal dot columns can be made long. This has been handled for the low speed printing.

This α pieces (seven pieces in FIG. 15) of ink droplets correspond to a character width setting value in the ink jet recording device. This setting value has been adjusted to vary the time interval between the longitudinal dot columns and handle for all of the printing speeds.

In the case of the low speed printing explained in FIG. 14 and FIG. 15, the character is a matrix character made up of the longitudinal five dots and transverse four lines. The character width setting value is also set to seven dots. In this case, the interval between the ink droplets, in which the respective longitudinal dot columns fly on the substantially equal flight trajectory, becomes 12 dots (time duration of forming 12 pieces of ink droplets). In the case of the low speed printing, the speed of the printing object is slow in comparison with the speed from when the ink droplets are formed and flied to when these are reached to the printing object. Therefore, the character width setting value is made large to then print out the longitudinal dot columns in the appropriate interval.

In this case, the time interval between the respective longitudinal dot columns is set to long when flying the ink droplets. For this reason, the influence of air resistance given to the preceding flied ink droplets is less in comparison with that given to the succeeding flied ink droplets. In other words, the air resistance given to the succeeding column ink droplets, which are flied on the substantially equal trajectory, is not so changed in comparison with the preceding flied ink droplets, in relation to the preceding column ink droplets.

Therefore, the air resistance given to the ink droplets of all of the longitudinal dot columns on flight, including a longitudinal first column, is substantially equal. The ink droplets of the respective longitudinal dot columns then delay evenly in an arrival time to the printing object, so that the printing of the longitudinal dot columns can be performed by a substantially uniform transverse pitch in accordance with an initial setting, and a printing visual quality is also fine.

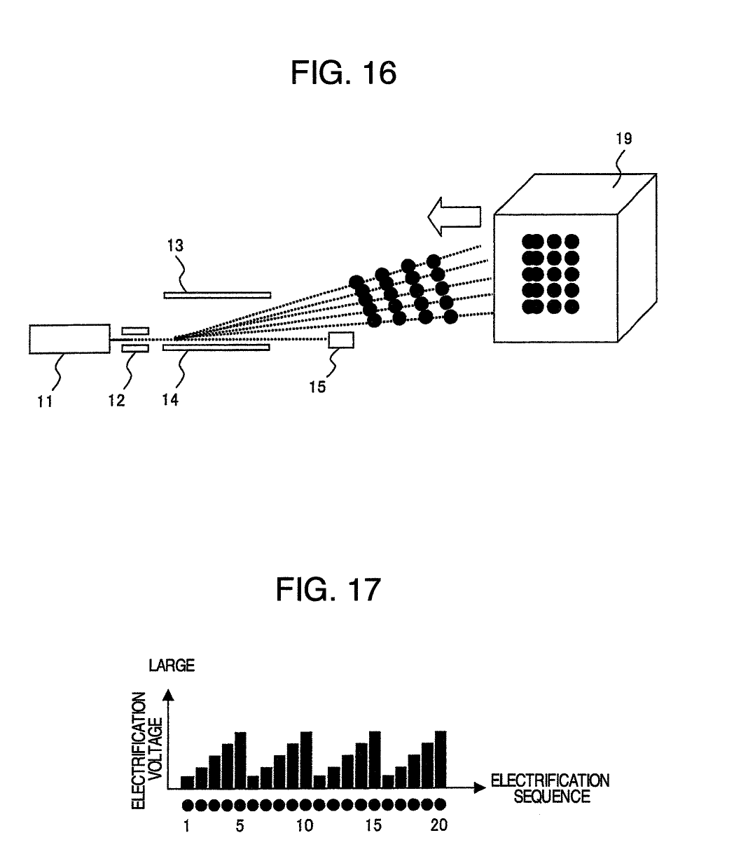

However, in the case of an after-mentioned high speed printing, it has been noted that a problem arises from the method of using the low speed printing. The high speed printing to be discussed here is that the ink jet recording device prints out on the printing object traveling at a speed higher than that assumed in the above-mentioned low speed printing. Hereinafter, a description will be concerned with a problem on the high speed printing with reference to FIG. 16 and FIG. 17. In addition, likewise the matrix character explained in FIG. 14, the matrix character printed on the printing object shown in FIG. 16 is also made up of the longitudinal five dots and transverse four lines. Further, likewise FIG. 14, the ink droplets in FIG. 16 indicate a condition where the ink droplets and its ink droplet group being flying on the flight trajectory are adhered to the printing object 19.

Assuming that the method of using the above-mentioned low speed printing is applied to the high speed printing, the interval between the respective longitudinal dot columns becomes narrow since the character width setting value must be set to small in order to handle the high speed printing. In the matrix character in FIG. 16, the character width setting value is set to a “0” dot. In this case, as shown in FIG. 17, the interval between the ink droplets, which are flied on the substantially equal flight trajectory in the respective longitudinal dot columns, becomes narrow by the amount of five dots (time duration of forming five ink droplets).

In this condition, the ink droplets on the longitudinal dot column of a first line fly while they undergo a large air resistance, since there are no flying ink droplets ahead. For this reason, the ink droplets on the first line decelerates on the flight due to the air resistance, therefore, it takes a time until the ink droplets are adhered to the printing object.

However, the ink droplets of printing the longitudinal dot column of the first line becomes a block on the flight trajectory of the ink droplets of printing the longitudinal dot columns of a subsequent line following the second line. This buffers against the air resistance of the longitudinal dots of the subsequent line following second line.

Therefore, in a flying speed of the ink droplets, a deceleration amount of the subsequent ink droplets following the second line becomes small in comparison with that of the ink droplets of the first line. Further, the delay of arrival time, when the ink droplets of printing the longitudinal dot columns of the subsequent line following the second line are reached to the printing object, becomes less than that of the ink droplets of printing the longitudinal dot column of the first line. The ink droplets of the subsequent line following the second line are not so changed in the deceleration amount of the flying speed between the respective columns, so that the printing can be performed without significantly changing the interval between columns.

On the high speed printing as described above, as shown in FIG. 16, the interval between the longitudinal dot columns of the first and second lines becomes narrower than that between the other columns, and the transverse pitch between the longitudinal dot columns is not aligned, therefore, there has been arisen a problem that the printing visual quality is bad.

An object of the invention is to realize a high printing quality by aligning the transverse pitch between the longitudinal dot columns as much as possible, when the ink jet recording device, which spouts the ink droplets consecutively, is in a condition of the high speed printing on the printing object conveying in high speed.

### DISCLOSURE OF THE INVENTION

An ink jet recording device of the invention includes a head provided with a nozzle that vibrates a pressurized ink and spouts so as to make a droplet form, electrification electrodes that apply an electric charge to ink droplets in accordance with printing information, deflection electrodes that generate an electric field to deflect electric charge applied ink droplets, and a gutter that collects non-electric charge applied ink droplets, characterized in that in relation to the head and the ink jet recording device that prints the ink droplets on a printing object which travels relatively in a substantially orthogonal direction in regard to a deflecting direction of the ink droplets, an interval between the ink droplets on a longitudinal dot column of a first line and those on the longitudinal dot column of a second line of character lines to be printed, is made longer than that between the ink droplets on the longitudinal dot column of a subsequent line following the second line.

According to the above-mentioned constitution, by considering a delay time period of flying the ink droplets, to be printed, on the longitudinal dot column of the first line, it is therefore possible to solve the problem of such that the transverse pitch of the longitudinal dot columns is non-uniform on the printing.

Further, an ink jet recording device of the invention includes a head provided with a nozzle that vibrates a pressurized ink and spouts so as to make a droplet form, electrification electrodes that apply an electric charge to ink droplets in accordance with printing information, deflection electrodes that generate an electric field to deflect electric charge applied ink droplets, and a gutter that collects non-electric charge applied ink droplets, characterized in that in relation to the head and the ink jet recording device that prints the ink droplets on a printing object which travels relatively in a substantially orthogonal direction in regard to a deflecting direction of the ink droplets, number of non-electric charge applied ink droplets to be added to between the ink droplets on a first line and those on a second line of character lines to be printed, is made greater than that of the non-electric charge applied ink droplets to be added to between the longitudinal dot columns of a subsequent line following the second line.

According to the above-mentioned constitution, the delay time period of flying the ink droplets, to be printed, on the longitudinal dot column of the first line is controlled by the non-charged ink droplets, it is therefore possible to solve the problem of such that the transverse pitch of the longitudinal dot columns is non-uniform on the printing.

Further, an ink jet recording device of the invention includes a head provided with a nozzle that vibrates a pressurized ink and spouts so as to make a droplet form, electrification electrodes that apply an electric charge to ink droplets in accordance with printing information, deflection electrodes that generate an electric field to deflect electric charge applied ink droplets, and a gutter that collects non-electric charge applied ink droplets, characterized in that in relation to the head and the ink jet recording device that prints the ink droplets on a printing object which travels relatively in a substantially orthogonal direction in regard to a deflecting direction of the ink droplets, a time period of not applying an electric charge to between the ink droplets on a first line and a second line of character lines to be printed, is made longer than that of applying the electric charge to the ink droplets between longitudinal dot columns of subsequent lines following the second line.

According to the above-mentioned constitution, the delay time period of flying the ink droplets, to be printed, on the longitudinal dot column of the first line is controlled by the non-charged ink droplets, it is therefore possible to solve the problem of such that the transverse pitch of the longitudinal dot columns is non-uniform on the printing.

Further, an ink jet recording device of the invention includes a head provided with a nozzle that vibrates a pressurized ink and spouts so as to make a droplet form, electrification electrodes that apply an electric charge to ink droplets in accordance with printing information, deflection electrodes that generate an electric field to deflect electric charge applied ink droplets, and a gutter that collects non-electric charge applied ink droplets, characterized in that in relation to the head and the ink jet recording device that prints the ink droplets on a printing object which travels relatively in a substantially orthogonal direction in regard to a deflecting direction of the ink droplets, when a relative speed of the printing object which travels relatively in regard to the head is slower than a predetermined speed, number of non-electric charge applied ink droplets to be added to between the ink droplets on a first line and those on a second line of character lines, is made equal to that of the non-electric charge applied ink droplet to be added to between the longitudinal dot columns of a subsequent line following the second line, and when the relative speed of the printing object which travels relatively in regard to the head is faster than the predetermined speed, number of non-electric charge applied ink droplets to be added to between the ink droplets on the first line and those on the second line of the character lines to be printed, is made greater than that of the non-electric charge applied ink droplets to be added to between the longitudinal dot columns of a subsequent line following the second line.

According to the above-mentioned constitution, in the printing object to be traveled in high speed, the delay time period of flying the ink droplets, to be printed, on the longitudinal dot column of the first line is controlled by the non-charged ink droplets, it is therefore possible to solve the problem of such that the transverse pitch of the longitudinal dot columns is non-uniform on the printing.

### BRIEF DESCRIPTION OF THE DIAGRAMS

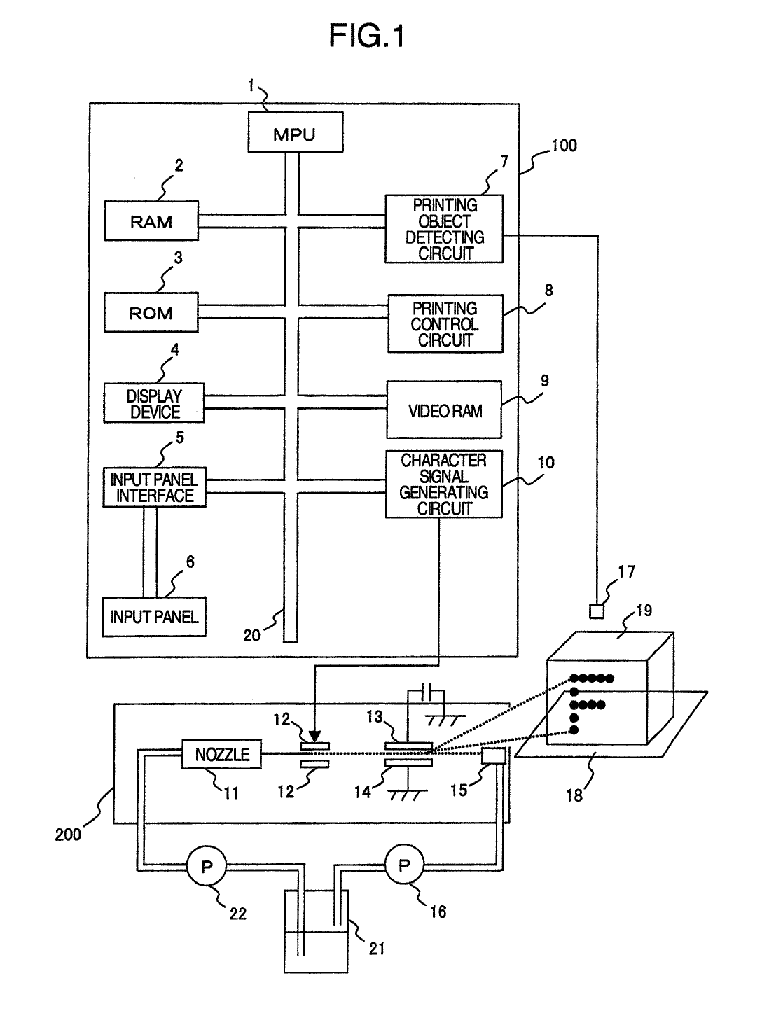

FIG. 1 is an explanatory diagram for explaining a constitution of an ink jet recording device in an embodiment of the invention.

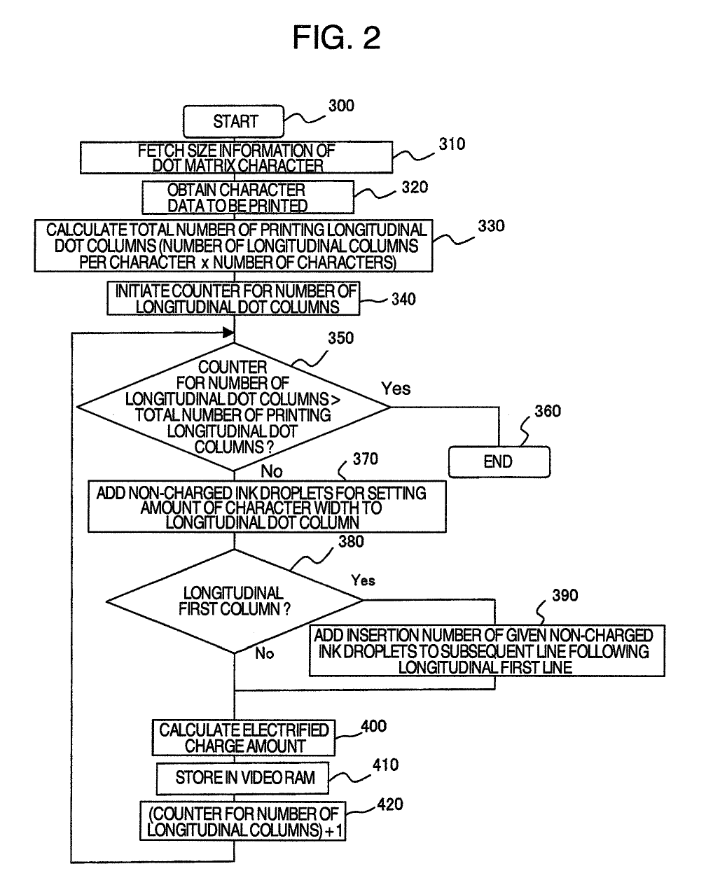

FIG. 2 shows a printing control flowchart of the ink jet recording device in the embodiment of the invention.

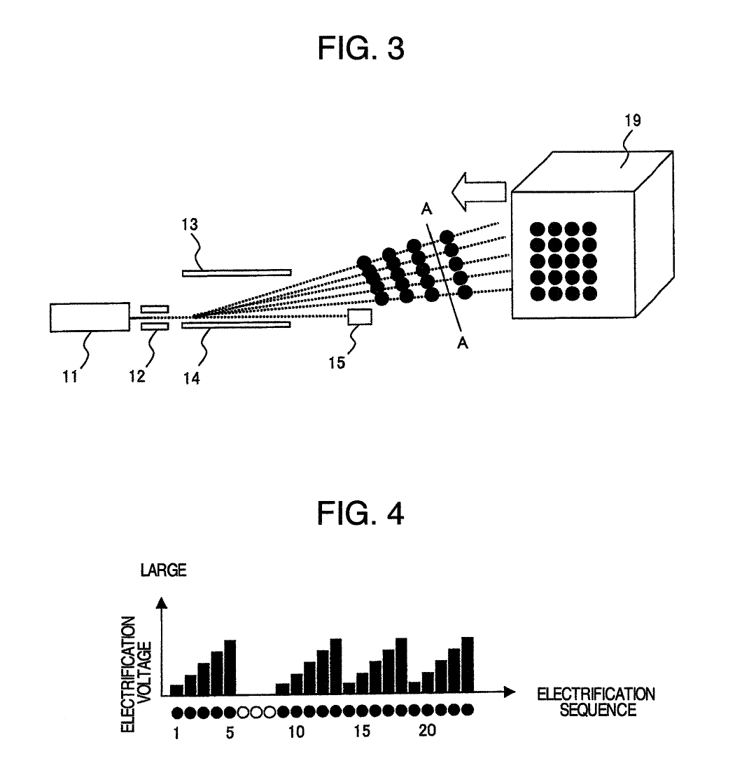

FIG. 3 is an explanatory diagram for explaining a printing example by the ink jet recording device in the embodiment of the invention.

FIG. 4 is an explanatory diagram for explaining an electrification signal in FIG. 3.

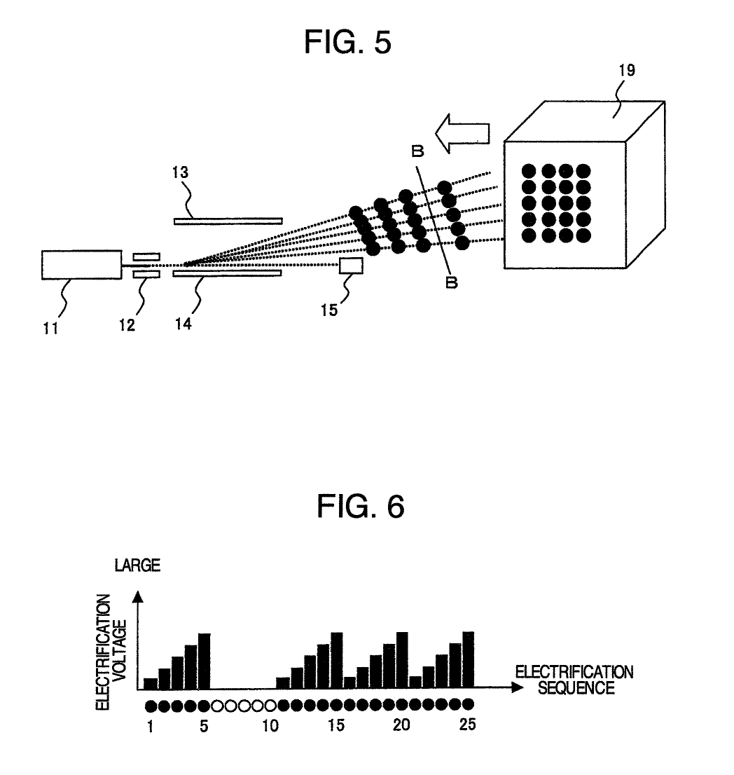

FIG. 5 is an explanatory diagram for explaining a printing example by the ink jet recording device in the embodiment of the invention.

FIG. 6 is an explanatory diagram for explaining the electrification signal in FIG. 5.

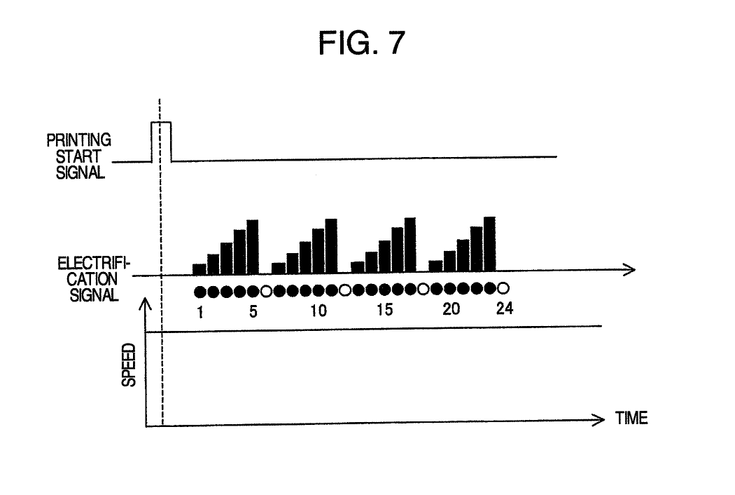

FIG. 7 is an explanatory diagram for explaining the electrification signal in a condition of a low speed/constant speed.

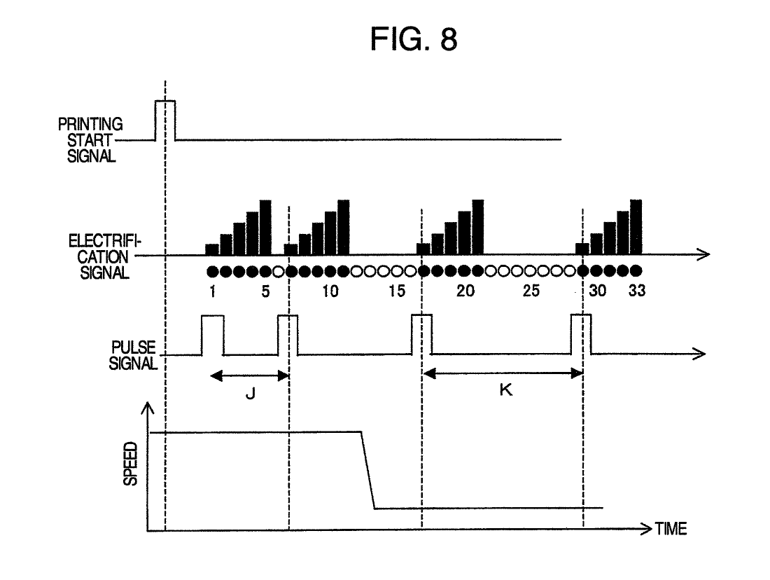

FIG. 8 is an explanatory diagram for explaining the electrification signal in a condition where there is a speed variation in high speed.

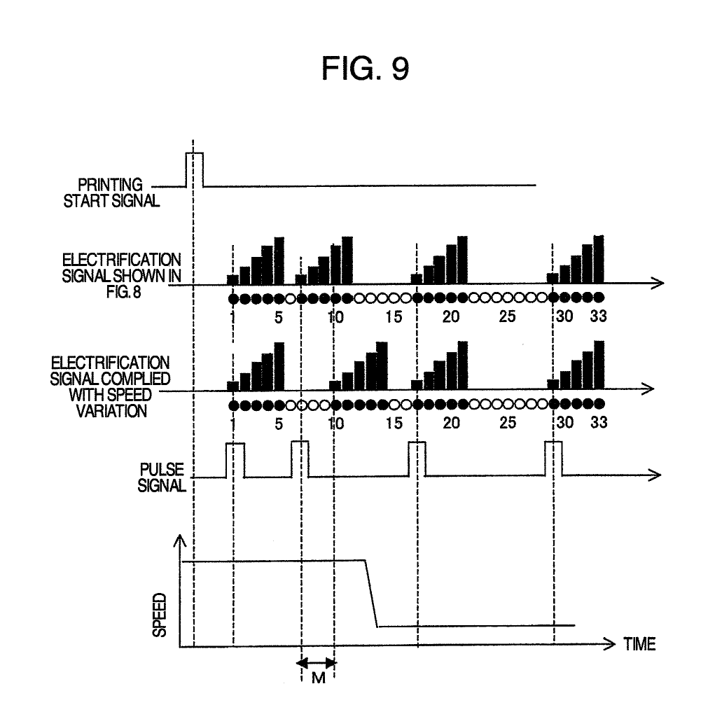

FIG. 9 is an explanatory diagram for explaining the electrification signal in the embodiment of the invention.

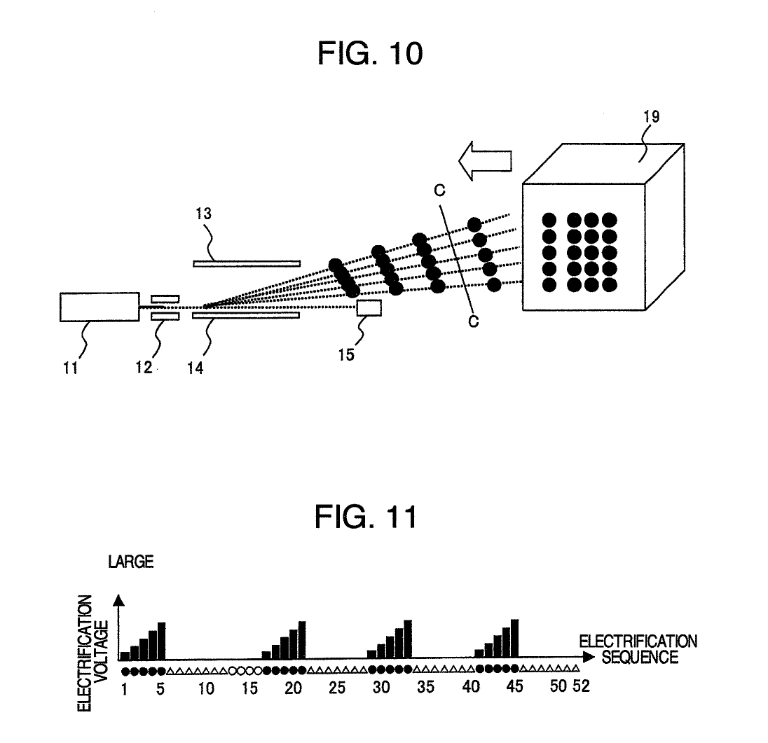

FIG. 10 is an explanatory diagram for explaining a printing condition of the ink jet recording device.

FIG. 11 is an explanatory diagram for explaining the electrification signal in FIG. 10.

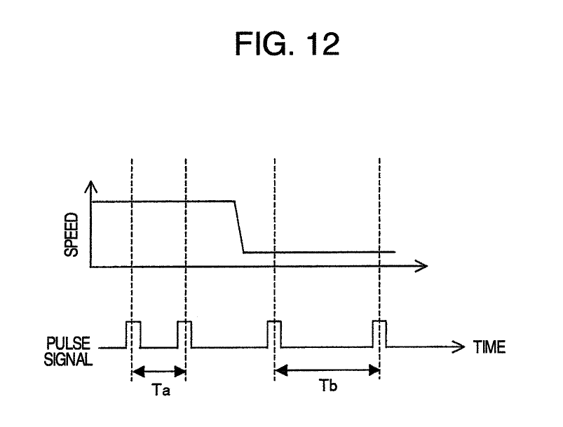

FIG. 12 is an explanatory diagram for explaining a switching of a printing system in response to a speed in the embodiment of the invention.

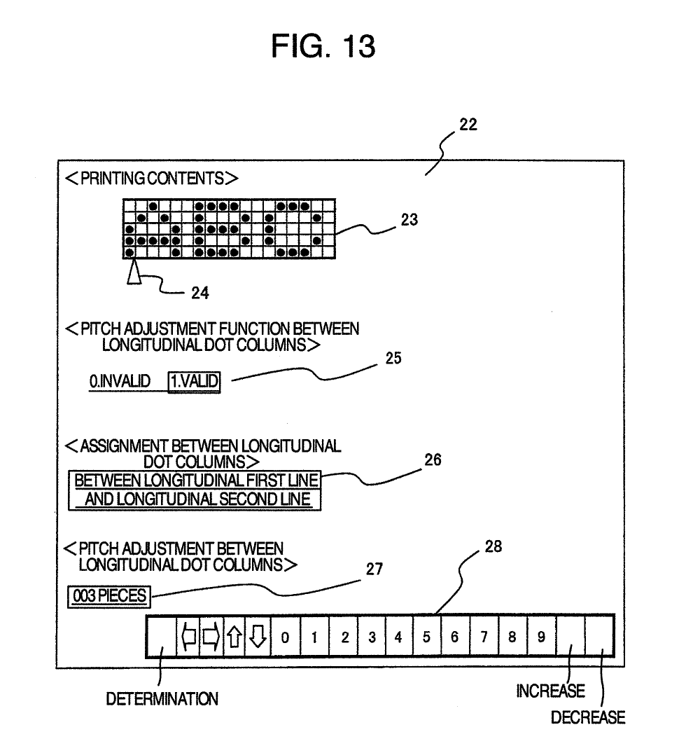

FIG. 13 is an explanatory diagram for explaining an operation unit in the embodiment of the invention.

FIG. 14 is an explanatory diagram for explaining a low speed printing condition in a conventional ink jet recording device.

FIG. 15 is an explanatory diagram for explaining an electric charged condition of an electrification voltage and ink droplets in FIG. 14.

FIG. 16 is an explanatory diagram for explaining a high speed printing condition in the conventional ink jet recording device.

FIG. 17 is an explanatory diagram for explaining the electric charged condition of the electrification voltage and ink droplets in FIG. 16.

### BEST MODE FOR CARRYING OUT THE INVENTION

A description will be concerned with an ink jet recording device in an embodiment of the invention. The ink jet recording device regarding this embodiment illustrated schematically in FIG. 1 is constituted mainly by two portions. One is a main body containing a case for housing an ink and an ink solvent, and a control unit 100 for controlling the apparatus. The other is a main body head 200 for spouting the ink delivered from the main body in accordance with the control of control unit in the main body. The main body is connected with the head 200 by flexible tubes for passing the ink and solvent, signal lines for supplying signals to the head 200 from the control unit 100 in the main body, and a power cable etc. for supplying an electric power.

The control unit 100 in the main body provides a MPU (Micro-Processing Unit) 1 to control the ink jet recording device entirely. A description will be concerned with a constitution indicating that the MPU 1 is connected through a bus line 20.

A RAM (Random-Access Memory) 2 stores temporarily data in the ink jet recording device. A ROM (Read-Only Memory) 3 stores programs etc. in advance.

A display device 4 displays contents, to be printed, received from the MPU 1. An input panel 6 has a switch group for receiving character information to be printed by an operator, and the character information received from the input panel 6 is sent to an input panel interface 5 connected to the bus line 20.

A printing object detecting circuit 7 is connected with a printing object detecting sensor 17 for detecting a printing object 19, to be printed, as a printing target to be traveled by a conveyor 18 as feed means, and the printing object detecting sensor 17 detects that the printing object 19 is detected, and sends a detected result to the MPU 1. The printing object detecting sensor 17 is provided on an external portion of the main body.

A printing control circuit 8 controls a printing operation of the ink jet recording device. A video RAM 9 stores video data as electrification information for electrifying ink droplets. Further, a character signal generating circuit 10 converts the video data into an electrification signal. The above-mentioned constitution is made up of connecting the MPU 1 via the bus line 20 in FIG. 1. However, this constitution may be provided as a function for the control unit of the main body, and may also be realized by other constitutions.

Further, the main body provides an ink tank 21 to accumulate the ink, and an ink supply pump 22 to pressurize the ink accumulated in the ink tank 21.

The head 200 has a nozzle 11 to vibrate the ink by a non-illustrated vibration body and spout as a droplet form, electrification electrodes 12 to apply an electric charge to that ink droplets, and a deflection electrode 13 and a minus deflection electrode 14 as deflection electrodes to generate an electric field and deflect electrified ink droplets. Further, the head 200 has a gutter 15 to collect the ink which is not deflected as ink droplets spouted from the nozzle 11 toward the printing object 19 and not used for the printing. The collected ink at the gutter 15 then passes through the tube to return to the ink tank 21 by a collection pump 16.

Next, a description will be concerned with a printing operation by the ink jet recording device in this embodiment. First, the description will be concerned with a printing preparation process for the printing object 19.

When the printing information made up of a printing condition containing characters to be printed, a printing character height, the number of stages of printing character lines, a printing character dot constitution indicated by column×line, etc. is entered from the input panel 6 via the input panel interface 5, the MPU 1 forms video data to be electrified the ink droplets in response to the printing information entered by the program stored in the ROM 3. The generated video data is stored in the video RAM 9 through the bus line 20.

Next, a description will be concerned with a printing process for the printing object 19. When the printing object detecting sensor 17 detects the printing object 19, a detected result is delivered to the MPU 1 through the printing object detecting circuit 7. The MPU 1 assumes that the detected result of the printing object 10 is a printing start signal, and then proceeds with the process.

When the MPU 1 receives the printing start signal, the video data stored in the video RAM 9 is sent to the character signal generating circuit 10 via the bus line 20. The character signal generating circuit 10 converts the received video data into an electrification signal. The printing control circuit 8 controls a timing of sending the electrification signal to the electrification electrodes 12.

The ink spouted from the nozzle 11 is made into droplets by vibrating the non-illustrated vibration body provided on the nozzle 11. In this droplet forming phenomenon, the ink is extended from the nozzle 11 in a columnar form to then separate from the end of a columnar ink and make into the droplets. The droplets are then flied in an ink spouted direction without change.

In the dribbled ink (ink droplets), when the ink is separated from the end of the columnar ink, a necessary electric charge is applied to the ink droplets in between the electrification electrodes 12. The electrified charge ink droplets pass through the electric field formed by the plus deflection electrode 13 and the minus deflection electrode 14 to thereby vary the flight trajectory in a direction in response to its electrification amount. The ink droplets flying in the new direction fly toward the printing object 19 to then adhere on the printing object 19.

In a relation between the electrification amount of the ink droplets and the flight trajectory thereof, the larger the electrification amount, the larger the deflection amount, and the smaller the electrification amount, the smaller the deflection amount.

The ink not used for the printing, that is, non-electrified ink droplets are collected at the gutter 15 to then return to the ink tank 21 by the collection pump 16.

A description will be concerned with a printing process in this embodiment, that is, the ink jet recording device made up of the above-mentioned constitution prints out on a desired position of the printing object 19 traveling in high speed, such that a difference of the transverse pitch between the respective longitudinal dot columns becomes less.

The ink droplets spouted from the nozzle 11 in high speed are made aligned in the longitudinal in regard to the printing object 19 by respectively varying the flight trajectory of some consecutive ink droplets, and the longitudinal one column is then printed out. Subsequently, the following longitudinal one column is printed by traveling the printing object 19 in a transverse direction. In this way, a matrix character is printed out, however, this matrix character is an aggregate of dots or blank domains. In addition, the blank domain (blank dot) is formed as ink droplets not electrified by a charge among the longitudinal dot columns, each of which has longitudinal “a” pieces, and these ink droplets are collected at the gutter 15.

As described above, the transverse pitch of the longitudinal dot columns becomes non-uniform on the high speed printing, which has been described as a problem. In order to solve the problem, an embodiment of the invention will be described in accordance with a flowchart in FIG. 2.

In this embodiment, first, an example will be described with a case where a matrix character made up of longitudinal five dots and transverse four lines is printed out on the printing object 19 traveling in high speed, when the traveling speed of the printing object 19 is substantially constant.

In the case of the ink jet recording device in this embodiment, a time interval between the ink droplets on the longitudinal dot column of the first line and the ink droplets on the longitudinal dot column of the second line both flied out from the head, for printing at every constant time period, is made longer than that between the ink droplets on the longitudinal dot column of a subsequent line following the second line.

Here, a description will be concerned with an embodiment of the case where blank dots of N-dot amount are provided into between the longitudinal dot column of the first line and that of the second line, and the time interval between the longitudinal dot column of the first line and that of the second line is made long by the blank dots of the N-dot amount. N is number of dots which are made into particles for an arbitrarily set constant cycle.

First, a software which can insert non-charged ink droplets, not to be printed, in between the longitudinal dot column of the first line and that of the second line to be printed as a first character among the character lines to be printed, is stored in the ROM 3, and information for an inserting number, as N pieces, of the non-charged ink droplets is also stored therein, in advance. MPU 1 then reads out and stands ready to start when setting a printing by using the software. This sets a start condition (step 300).

When an operator enters character information containing characters to be printed, a printing condition, etc. from the input panel 6, size information of a dot matrix character is fetched in (step 310), character data to be printed is obtained (step 320), and a total number of printing longitudinal dot columns to be printed by using the dot matrix character and a digit number of the printing data is calculated from the entered character (step 330). A dot counter for number of longitudinal dot columns is also initiated (step 340).

Next, the longitudinal dot column of the first line to be printed first is set to a count “1” to then compare with the total number of printing longitudinal dot columns (step 350). The count is performed from the longitudinal dot column to be printed first to that to be printed last, and the count is then terminated when it exceeds the total number of printing longitudinal dot columns (step 360). After the comparison, a predetermined setting value or number of dots corresponding to an amount of character width indicated by the operator is added to the longitudinal dot column (step 370). Here, the number of blank dots to be added is the number of dots to be added to all of the longitudinal dot columns.

Next, the longitudinal dot column is determined whether it is the longitudinal dot column of the first line (step 380). If it is the longitudinal dot column of the first line, the amount of N-dot of the non-charged ink droplets as an amount of predetermined number is added to the longitudinal dot column of the first line (step 390). Subsequently, an electrified charge amount for the respective ink droplets is calculated in response to the character data (step 400). If the ink droplets are of needed ones, the electrified charge amount is calculated in response to a deflection position. If the ink droplets are of not needed ones for the printing, they are assumed that these ink droplets are of the non-charged ink droplets not to be printed, as electrification amount “0” and video data of these are written in the video RAM 9 in FIG. 1 via the bus line 21 (step 410). The counter of longitudinal dot column is increment by “1” at every time that the video data of each of the longitudinal dot columns is written in the video RAM 9 (step 420).

The process returns to the step 350 when terminating the process at the step 420, and the above-mentioned processes are repeated for each of all of the longitudinal dot columns. This process writes, in the video RAM 9 sequentially, the video data of respective columns and the video data of the non-charged ink droplets, not to be printed, to be inserted between the longitudinal dot column of the first line and that of the second line.

By performing the above-mentioned processes, the video data stored in the video RAM 9 is sent to the character signal generating circuit 10 via the bus line 21. The video data is transformed into a stepwise waveform of the electrification signal in the character signal generating circuit 10.

As describe above, the non-charged ink droplets of the amount of given N-dot can be inserted into between the longitudinal dot column of the first line to be printed first and that of the second line.

In a printing example of FIG. 3, when printing the matrix character made up of arranging the longitudinal five-dot column in four lines, the non-charged ink droplets, not to be printed, the amount of three dots are inserted into between the longitudinal dot column of the first line, to be printed first, and that of the second line. Information that is inserted as the amount of three dots may be written in the ROM 3 in advance, and may be used as a predetermined value when entering character column information as described later.

By the process shown in FIG. 2, the non-charged ink droplets, not to be printed, of the amount of three dots are set in between the columns of the given first and second lines. In FIG. 3, the interval of the amount of three dots is given as a space to between the ink droplet group of the first line and that of the second line flied on the fight trajectory. As shown in FIG. 4, it is understandable that there are ink droplets, the amount of three dots of which are not made into electrification, such that three non-charged ink droplets are formed behind the ink droplet group (first to fifth ink droplet) constituting the first line. The non-charged ink droplets are not inserted, as setting value “0” in the character width, into between the ink droplet group (ninth to thirteenth ink droplet) constituting the second line and the ink droplet group (fourteenth to eighteenth ink droplet) constituting the third line. In this way, the interval indicated by a line A-A can be formed of FIG. 3.

In the conventional high speed printing, there was a problem that the visual quality of printing is bad since the interval between the columns of first two lines is made narrow due to the difference of the air resistance given to the longitudinal dot column of the first line and that of the second line. However, from the constitution of this embodiment, a delay time is predicted until the longitudinal dot column of the first line is arrived at the printing object in advance, and a time corresponding to the delay time is compensated by inserting the non-charged ink droplets. In this way, the ink droplet group of the subsequent line following the second line catches up at a time when ink droplet group of the first line reaches to the printing object 19. It is therefore possible to print an appropriate arrangement at the time when the ink droplet group of the respective longitudinal dot columns is adhered to the printing object 19, that is, it is possible to realize a printing having a less transverse pitch difference between the respective longitudinal dot columns on the high speed printing. The difference is manifestly apparent from comparison with the result of the conventional high speed printing illustrated in FIG. 15.

Next, a description will be concerned with a case of specifying the number of pieces of N-dot, without arbitrarily setting the number of dots so that the time interval between the longitudinal dot column of the first line and that of the second line is set to longer than that between the columns of the subsequent line following the second line by the amount of N-dot. In a condition where the speed is constant, when printing a matrix character made up of longitudinal Y dots, the time interval between the longitudinal dot columns of the first line and that of the second line to be printed first is spaced as an interval by the amount of Y dots, that is, by a length of the longitudinal dot column.

Specific realization method and implementation procedure are identical to the above-mentioned embodiment. It is then different in that equal number of the non-charged ink droplets to the number of ink droplets of the longitudinal dot column is set in between the ink droplet group of the first line and that of the second line. In this way, it is also possible to reduce the problem of such non-uniform transverse pitch of the longitudinal dot columns on the conventional high speed printing. An example of the above case is shown in FIG. 5.

In the example of FIG. 5, the printing was performed by electrifying the dribbled form ink droplets between the electrification electrodes 12 on the basis of the electrification waveform shown in FIG. 6. In the printing of the dot matrix character made up of the longitudinal five dots and transverse four lines shown in FIG. 5, the non-charged ink droplets not to be used for the printing of the amount of five dots are inserted into between the longitudinal dot column of the first line to be printed first and that of the second line so that a space indicated by a line B-B is formed. In this way, it is possible to compensate the interval, which is made narrow, from the ink droplet group of the subsequent line following the second line by decelerating the ink droplets of the first line, likewise of the printing condition shown in FIG. 3, it is possible to improve the interval between the columns better than the conventional high speed printing.

Next, a description will be concerned with an embodiment from an aspect of a printing timing for the respective longitudinal dot columns. In the embodiment having been described above, the longitudinal dot column of the first line may be printed out first, and the printing timing for the longitudinal dot column of the second line may be printed with a delay by the amount of N-dot rather than the original printing timing, when printing the matrix character made up of the longitudinal Y dots of the character lines to be printed out. The original printing timing means a timing of spouting the ink droplet group from the head when the printing timing for every longitudinal dot column is synchronized with the traveling of the printing object.

A description will be concerned with a printing control of the conventional ink jet recording device in response to the traveling speed (relative speed between the head and the printing object) of the printing object to be conveyed, with reference to FIG. 7 and FIG. 8.

First, FIG. 7 shows a case where the traveling speed of the printing object 19 is constant as indicated a relation between the time and speed of the lowermost stage. When the control unit 100 receives a detected signal as a momentum of a printing start from the printing object detecting sensor 17, that is, as a printing start signal (uppermost stage in FIG. 7), all of the longitudinal dot columns of the printing data were consecutively printed out at once, after elapsing a predetermined time period to print out on a predetermined printing domain. As further shown in FIG. 8, when the traveling speed of the printing object is varied, the detected signal from the printing object detecting sensor 17 is the momentum of printing start, however, the dots of the amount of the longitudinal one column was printed out at every detection of one pulse, on the basis of pulse signals obtained from an external device (not shown) such as an encoder installed on the feed means which conveys the printing object.

When the traveling speed of the printing object 19 in FIG. 7 is constant, the printing control is performed by such that the time interval between the longitudinal dot column of the first line and that of the second line is made longer than that between the longitudinal dot columns of the subsequent line following the second line, as described above. Specifically, the first to fifth ink droplet to be printed out as the longitudinal dot column of the first line are applied by the electric charge in FIG. 7, and the sixth ink droplet is only made into the non-charged ink droplet, however, the seventh to ninth ink droplet are made into the non-charged ink droplets, for example.

In this case, the three dots are shifted, therefore, the tenth to fourteenth ink droplet become the longitudinal dot column of the second line.

When the traveling speed of the printing object 19 in FIG. 8 is varied, the pulse signals output from the encoder comply with the traveling speed of the printing object 19, and the interval between the generated pulse signals is determined in response to this speed.

As shown in FIG. 8, when the traveling speed of the printing object 19 becomes slow, the interval between the pulse signals becomes wide so as to be pulse intervals J to K to thereby delay the timing of the printing.

In contrary, when the speed becomes fast, the interval between the pulse signals becomes narrow to make the print timing fast and thereby handle the high speed printing. In contrast to such time of the speed variation, the printing timing of the original longitudinal second line and an input timing of the pulse signals complied with the traveling speed of the printing object 19 are shifted to by the amount of N-bit, as arbitrary number, to be able to print out the matrix character in accordance with an appropriate timing.

FIG. 9 shows an example indicating that the printing timing of the original second line synchronized with the speed variation is made delayed by the amount of three dots to thereby print out it. A printing start signal is the detected signal output from the printing object detecting sensor 17. Similarly to FIG. 8, the pulse signal is a signal obtained from an external device (not shown) such as an encoder installed on the feed means which conveys the printing object 19.

In this embodiment, when the printing object 19 travels in high speed with the traveling speed varied, it is possible to perform the printing by widening the interval time between the longitudinal first and second lines to be made the transverse pitch difference of the longitudinal dot columns less. In FIG. 9, the non-charged ink droplets of the amount of three dots are generated for the second pulse signal as the original printing timing (interval M in FIG. 9).

Further, as described above with reference to FIG. 9, after printing the longitudinal dot column of the first line, when the matrix character made up of the longitudinal Y dots is printed out by indicating the amount of dots which makes the printing timing delayed, in contrast to the printing performed such that the deflection of the ink droplets is delayed by the amount of N-dot, as arbitrary number, rather the printing timing of the subsequent line following the second line than the original printing timing, the printing timing of the longitudinal second line may be delayed by the amount of Y-dot.

In this way, it is possible to reduce the problem of such that the transverse pitch of the longitudinal dot columns becomes non-uniform, when printing on the printing object traveling in high speed.

Next, a description will be concerned with an embodiment applied the above-mentioned embodiment to the traveling speed variation of the printing object. As described with reference to FIG. 15, when the high speed printing is performed on the printing object traveling in high speed, the interval between the respective longitudinal dot columns becomes narrow. Besides, the air resistance given to the ink droplets, to be printed, on the longitudinal dot column of the first line is larger than that given to the ink droplets of the other longitudinal dot columns, so that the arrival time to the printing object is delayed.

Consequently, as describe above, the time interval is spaced between the ink droplets of the longitudinal dot column of the first line to be printed and the ink droplets of the longitudinal dot column of the second line to be printed, and the amount of delay time is compensated by inserting the non-charged ink droplets in the embodiment, it is therefore possible to print out with a less transverse pitch difference between the respective longitudinal dot columns in the high speed printing.

However, when the above-mentioned embodiment is applied to the low speed printing, a problem arises as shown in FIG. 10 and FIG. 11. In the case of the low speed printing on the printing object which travels relatively in low traveling speed, the non-charged ink droplets of the amount of character width to be inserted between the respective longitudinal dot columns are added as indicated by “Δ” which is not electrified by the electrification waveform in FIG. 11 in order to originally handle the printing in low speed.

In this case, the interval between the respective longitudinal dot columns is originally widened in order to handle the printing object 19 in the low traveling speed. For this reason, the ink droplets constituting the respective longitudinal dot columns undergo the influence of a substantially equal air resistance on their flight, therefore, the effect of the non-charged ink droplets as described above, for adjusting the transverse pitch given to between the first and second lines, disappears in the low speed printing. In contrast, in the case of applying to the low speed printing without change, a problem arises such that the transverse pitch between the longitudinal dot columns of the first line and that of the second line is widened.

Consequently, in order to obtain the printing of less transverse pitch difference between the respective longitudinal dot columns even though the traveling speed of the printing object is varied, a substantially equal time interval is made so as to give to between the respective longitudinal dot columns in response to the traveling speed of the printing object in the low speed printing. More specifically, the non-charged ink droplets of the number of pieces in response to the traveling speed of the printing object are added, and the time interval between the longitudinal dot column of the first line and that of the second line, as described above, is made longer than that of the longitudinal dot column of the subsequent line following the second line in the high speed printing. As one of the embodiments, and the time interval between the respective longitudinal dot columns is switched over in response to the speed by monitoring the traveling speed of the printing object.

In the case where the encoder (not shown) is installed on the feed means to convey the printing object 19 and monitor the traveling speed of the printing object, the switching procedure will be performed, as follows. The time interval between the pulse signals to be a decision criterion is stored in the RAM 2 in advance, and if the interval of the pulse signals detected by the encoder is shorter than the decision criterion (Ta) as shown in FIG. 12, the MPU 1 commands to the printing control circuit 8 so as to print out by the printing method described above-mentioned embodiment. Further, if the interval of the pulse signals is longer than the decision criterion (Tb), the MPU 1 switches over the time interval so as to obtain a time interval (transverse pitch) substantially equal to the interval between the respective longitudinal dot columns in response to the traveling speed of the printing object. By controlling the procedure as described above, the printing of the less transverse pitch difference between the respective longitudinal dot columns can be performed even though the traveling speed of the printing object is in either the low or high speed.

In addition, the example using the encoder has been described in the above-mentioned embodiment, however, the variation of the traveling speed may be detected from a detected interval of the printing object 19 by the printing object detecting sensor 17 to then switch over the time interval between the respective longitudinal dot columns.

In the embodiments having been described above, the operation may be set arbitrarily to whether the above-mentioned function can be used from the input panel 6 or an external device. FIG. 13 shows an example of a touch panel 22 combined together with a display unit.

The touch panel 22 combined with the display unit is provided on the main body or separated from it, and connected with the control unit in the main body by a wire or wireless. A result entered into that is sent as an input signal to the MPU 1 through the bus line 20.

The touch panel 22 provides with a printing character display unit 23 to display displaying data received from the MPU 1. Further, a matrix switch (not shown) is arranged on the surface of touch panel 22. At a lower portion of the matrix character displayed on the printing character display unit 23, an indication cursor 24 movable to the left and right on the printing character display unit 23 is provided so as to indicate a space between the longitudinal dot columns. As an input is entered into an operation unit 28 provided on the touch panel 22, the indication cursor 24 moves. The non-charged ink droplets described with the above-mentioned embodiment can then be inserted into between the longitudinal dot columns indicated by the indication cursor 24. The MPU 1 sets the longitudinal dot columns to be inserted the non-charged ink droplets by the input from the operation unit 28.

Further, the touch panel 22 displays a selection domain-pitch adjustment function between longitudinal dot columns 25, an assignment domain between longitudinal dot columns 26, and a pitch adjustment domain between longitudinal dot columns 27. The respective input operations to the operation unit 28 assign that the pitch adjustment function between the longitudinal dot columns is valid or invalid, the interval of longitudinal dot columns is assigned for insertion, and the number of non-charged ink droplets to be inserted is assigned. These input results are sent to the MPU 1 through the bus line 20. It is therefore possible to perform a pitch micro-adjustment between the respective longitudinal dot columns.

According to the above embodiments, the ink jet recording device provides that it is possible to make the transverse pitch difference between the respective longitudinal dot columns less, even though the printing is applied to the printing object traveling in high speed.

Further, the embodiments have been described with the matrix character, however, they are not limited obviously to the matrix character as a printing target. The above-mentioned embodiments are valid for the case where the magnitude of deceleration for the flying ink droplet group to print out the longitudinal dot column of the first line is larger compared with that of the ink droplet group to be printed the subsequent line following the second line due to the air resistance. For example, the case is for printing out a barcode. A barcode is used for printing out an entire longitudinal dot column as one bar, therefore, the influence of the air resistance is extended over the subsequent line following the second line on all of the flight trajectories. For this reason, when the embodiments are applied to a case of printing out the barcode on the printing object 19 traveling in high speed, a recording accuracy is enhanced in a barcode reader since the first and second lines are clearly separated to print out as a barcode.

Further, the above-mentioned embodiments have also been described with the case where the character lines to be printed is for one stage, but not limited to this case. This is because the problem solved by the embodiments arises for each of the first lines of the character lines to be printed out in plural stages. That is, the air resistance given to the ink droplets of the first longitudinal dot column among the respective stages is substantially equal, respectively. In this case, the addition of non-charged ink droplets performed by the above-mentioned embodiment is given prior to the ink droplets formed the two lines for each of the stages, therefore, the advantage of the invention is obtained even in the case of printing the character lines of the plural stages.

1. An ink jet recording device characterized in that: the ink jet recording device comprises a head which includes a nozzle that vibrates a pressurized ink and spouts so as to make a droplet form, electrification electrodes that apply an electric charge to ink droplets in accordance with printing information, deflection electrodes that generate an electric field to deflect electric charge applied ink droplets, and a gutter that collects non-electric charge applied ink droplets, wherein the ink jet recording device prints the ink droplets on a printing object which travels relatively in a substantially orthogonal direction in regard to a deflecting direction of the head and the ink droplets, and wherein an interval between the ink droplets of a first line and the ink droplets of a second line of character lines to be printed, is longer than an ink droplet interval between longitudinal dot columns of a subsequent line following the second line.

2. The ink jet recording device according to claim 1, wherein a relative speed of the printing object is substantially equal to the head.

3. The ink jet recording device according to claim 1, wherein the interval between the ink droplets of the first line and those of the second line of the character lines to be printed is longer than the ink droplet interval between the longitudinal dot columns of the subsequent line following the second line by a time duration of forming a plurality of ink droplets.

4. The ink jet recording device according to claim 1, wherein when an electrification start interval for the ink droplets on each of the longitudinal dot columns is determined by synchronizing with a traveling of the printing object, an electrification start for the ink droplets on the longitudinal dot column of the second line is made delayed without synchronizing with the traveling of the printing object.

5. The ink jet recording device according to claim 4, wherein the electrification start for the ink droplets on the longitudinal dot column of the second line is made delayed to start the electrification by the time duration of forming the plurality of ink droplets, from a timing synchronized with the traveling of the printing object.

6. The ink jet recording device according to claim 1, wherein a relative speed between the head and the printing object is monitored, and if the relative speed is faster or equal to a predetermined speed, the interval between the ink droplets of the first line and those of the second line of character lines to be printed, is made longer than the ink droplet interval between the longitudinal dot columns of the subsequent line following the second line.

7. The ink jet recording device according to claim 1, wherein number of pieces of the plurality of ink droplets is number of pieces set from externally.

8. An ink jet recording device comprising a head which includes a nozzle that vibrates a pressurized ink and spouts so as to make a droplet form, electrification electrodes that apply an electric charge to ink droplets in accordance with printing information, deflection electrodes that generate an electric field to deflect electric charge applied ink droplets, and a gutter that collects non-electric charge applied ink droplets, wherein the ink jet recording device prints the ink droplets on a printing object which travels relatively in a substantially orthogonal direction in regard to a deflecting direction of the head and the ink droplets, and wherein number of non-electric charge applied ink droplets to be added to between the ink droplets of a first line and the ink droplets of a second line of character lines to be printed, is made greater than that of the non-electric charge applied ink droplets to be added to between the longitudinal dot columns of a subsequent line following the second line.

9. The ink jet recording device according to claim 8, wherein a relative speed of the printing object is substantially equal to the head.

10. The ink jet recording device according to claim 8, wherein when an electrification start interval for the ink droplets on the respective longitudinal dot columns is determined by synchronizing with a traveling of the printing object, an electrification start for the ink droplets on the longitudinal dot column of the second line is made delayed without synchronizing with the traveling of the printing object.

11. The ink jet recording device according to claim 8, wherein a relative speed between the head and the printing object is monitored, and if the relative speed is faster or equal to a predetermined speed, the interval between the ink droplets of the first line and those of the second line of character lines to be printed, is made longer than the ink droplet interval between the longitudinal dot columns of the subsequent line following the second line.

12. An ink jet recording device comprising a head which includes a nozzle that vibrates a pressurized ink and spouts so as to make a droplet form, electrification electrodes that apply an electric charge to ink droplets in accordance with printing information, deflection electrodes that generate an electric field to deflect electric charge applied ink droplets, and a gutter that collects non-electric charge applied ink droplets, wherein the ink jet recording device prints the ink droplets on a printing object which travels relatively in a substantially orthogonal direction in regard to a deflecting direction of the head and the ink droplets, and wherein a time period of not applying an electric charge to between the ink droplets of a first line and a second line of character lines to be printed, is made longer than that of not applying the electric charge to the ink droplets between longitudinal dot column of a subsequent line following the second line.

13. The ink jet recording device according to claim 12, wherein a relative speed of the printing object is substantially equal to the head.

14. The ink jet recording device according to claim 12, wherein when an electrification start interval for the ink droplets on the respective longitudinal dot columns is determined by synchronizing with a traveling of the printing object, an electrification start for the ink droplets on the longitudinal dot column of the second line is made delayed without synchronizing with the traveling of the printing object.

15. The ink jet recording device according to claim 12, wherein a relative speed between the head and the printing object is monitored, and if the relative speed is faster or equal to a predetermined speed, the interval between the ink droplets of the first line and those of the second line of character lines to be printed is made longer than the ink droplet interval between the longitudinal dot columns of the subsequent line following the second line.

16-19. (canceled)
